(19) United States
(12) Patent Application Publication
(10) Pub. No.: US 2008/0063428 A1
(43) Pub. Date: Mar. 13, 2008

(54) Developing unit and image forming apparatus

(75) Inventor: Jong-hwa Joo, Seoul (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/708,008

(22) Filed: Feb. 20, 2007

(30) Foreign Application Priority Data
Sep. 11, 2006 (KR) 2006-87685

(51) Int. Cl. G03G 21/18; G03G 15/08; G03G 15/00

(52) U.S. Cl. 399/111; 399/117; 399/279

(57) ABSTRACT

A developing unit and an image forming apparatus includes an image carrier, a developer container to contain a developer, a developer carrier to transfer the developer of the developer container to the image carrier, support brackets, fixed to the developer container, to rotatably support the developer carrier, frames to rotatably support the image carrier; and a hinge shaft fixed to each of the support brackets and supported by the frames.

### CROSS-REFERENCE TO RELATED APPLICATIONS

This application claims priority under 35 U.S.C. § 119 (a) of Korean Patent Application No. 10-2006-0087685, filed on Sep. 11, 2006, in the Korean Intellectual Property Office; the disclosure of which is incorporated herein by reference in its entirety.

### BACKGROUND OF THE INVENTION

1. Field of the Invention

The present general inventive concept relates to a developing unit and an image forming apparatus including the same. More particularly, the present general inventive concept relates to a developing unit and an image forming apparatus including the same, to transfer a predetermined amount of a developer to an image carrier from a developer carrier to form an image.

2. Description of the Related Art

In general, image forming apparatuses such as laser printers, light emitting diode (LED) printers, facsimiles using standard paper, digital copiers or the like form a predetermined electrostatic latent image on an image carrier, such as a photosensitive drum, using a laser scanning unit. A developer is transferred to the electrostatic latent image region by a developing unit to develop the latent image, and thus a visual image corresponding to the desired image is formed. The visual image formed on the image carrier is transferred to a printing medium, such as a sheet of paper, by a transferring unit. The printing medium bearing the visual image passes through a fixing unit, where the image is fixed under high temperature and pressure, and then discharged to the outside of the apparatus.

One example of the developing unit is described below. The developing unit includes an image carrier, a developer container to contain the developer such as a toner, a developer carrier to supply the developer of the developer container to the image carrier, and a developer amount regulating member to regulate the amount of developer supplied to the image carrier by the developer carrier.

In the developing unit configured as mentioned above, it is very important to achieve precise positioning and alignment of the developer carrier and the developer amount regulating member, and to achieve precise positioning and alignment (developing gap) of the developer carrier and the image carrier.

According to the precise positioning and alignment of each of the developer carrier, the developer amount regulating member and the image carrier as described above, the amount of developer transferred to the electrostatic latent image on the image carrier and the development of the developer can be controlled. The precise positioning and alignment of each component such as the developer carrier, the developer amount regulating member, and the image carrier is very important to prevent a decrease in image density and/or a degradation of image quality.

However, many parts are needed to properly install, position and/or align the above-noted components relative to the developer container. Accordingly, it is difficult to stabilize and/or continuously maintain the precise positioning and/or alignment of each of the developer carrier, the developer amount regulating member, and the image carrier.

### SUMMARY OF THE INVENTION

The present general inventive concept provides a developing unit and an image forming apparatus including the same having improved ease of installation, precise positioning and/or alignment of a developer carrier, a developer amount regulating member and an image carrier by simplifying the configuration of the developing unit.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a developing unit, which includes an image carrier, a developer container to store (or to hold) a developer, a developer carrier to transfer the developer of the developer container to the image carrier, support brackets, fixed to the developer container, to rotatably support the developer carrier, frames to rotatably support the image carrier; and a hinge shaft fixed to each of the support brackets and supported by the frames.

A pair of support brackets may be respectively fixed to both sides of the developer container.

Additionally, both ends of the hinge shaft may be fixed to each of the pair of support brackets.

Both ends of the hinge shaft may be rotatably supported by a pair of frames with one frame disposed on each end of the hinge shaft.

The developing unit may further include a developer amount regulating member which is supported by the support brackets to regulate the amount of developer supplied to the image carrier by the developer carrier.

The foregoing and/or other aspects and utilities of the present general inventive concept may also be achieved by providing an image forming apparatus, which includes a main body of the image forming apparatus, and a developing unit, mounted in the main body, to form an image and to transfer the formed image to a printing medium passing between a transferring roller and the developing unit. The developing unit may include an image carrier, a developer container to store (or to hold) a developer, a developer carrier to transfer the developer of the developer container to the image carrier, support brackets, fixed to the developer container, to rotatably support the developer carrier, frames to rotatably support the image carrier, and a hinge shaft fixed to each of the support brackets and supported by the frames.

The foregoing and/or other aspects and utilities of the present general inventive concept may also be achieved by providing a developing unit including a frame, a developer container to contain a developer, an image carrier rotatably coupled to the frame, a developer carrier to supply the developer of the developer container to the image carrier, and a support bracket disposed between the frame and the developer carrier and to maintain a distance with the image carrier.

The developing unit can include a developer amount regulating member to regulate an amount of the developer transferred to an image carrier by a developer carrier. The developer amount regulating member may be supported by or coupled to the brackets at opposing ends of the developer amount regulating member. The developer amount regulating member may have an L shaped configuration.

The developer carrier may be supported by the frames at opposing ends of the developer carrier. The developer carrier may be a roller. The support brackets may be fixedly coupled to the frames to support the developer carrier with respect to the frames. The support brackets may be spaced apart from a position of the frames where the image carrier is rotatably coupled to the frames.

The image carrier may be supported by the brackets at opposing ends of the image carrier. The image carrier may be a roller.

The developer carrier may be disposed adjacent to the image carrier. The developer carrier may also be disposed above the image carrier.

The developing unit may include a supplying roller disposed inside the developer container to mix the unused developer.

The developing unit may be disposed inside an image forming apparatus.

The developing unit may further include a hinge shaft coupled to the frames through the support brackets at a first position, where the developer carrier is rotatably coupled to the support brackets at a second position. The first and second positions may be separated from each other by a distance.

A rotation axis of the developer carrier may form an angle with a rotation axis of the image carrier with respect to the hinge shaft.

The frames may include an image carrier boss to be coupled to the image carrier and a bracket boss to be coupled to the support brackets.

The foregoing and/or other aspects and utilities of the present general inventive concept may also be achieved by providing an image forming apparatus including a main body having a unit to feed a printing medium, and a developing unit disposed in the main body to form an image on the printing medium, the developing unit including a frame, a developer container to contain a developer, an image carrier rotatably coupled to the frame, a developer carrier to supply the developer of the developer container to the image carrier, and a support bracket disposed between the frame and the developer carrier and to maintain a distance with the image carrier.

The foregoing and/or other aspects and utilities of the present general inventive concept may also be achieved by providing a development unit including a frame to which an image carrier is rotatably connected, a developer container connected to the frame, a support bracket connected to the frame and having a boss unit, and a developer carrier rotatably connected to the boss unit of the support bracket with respect to the image carrier to supply the developer from the developer container to the image carrier.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 shows a schematic configuration of an image forming apparatus according to an exemplary embodiment of the present general inventive concept;

FIG. 2 is a perspective view of a developing unit according to an exemplary embodiment of the present general inventive concept;

FIG. 3 is a exploded perspective view of the developing unit of FIG. 2; and

FIG. 4 is a close-up perspective view illustrating the main parts of the developing unit of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

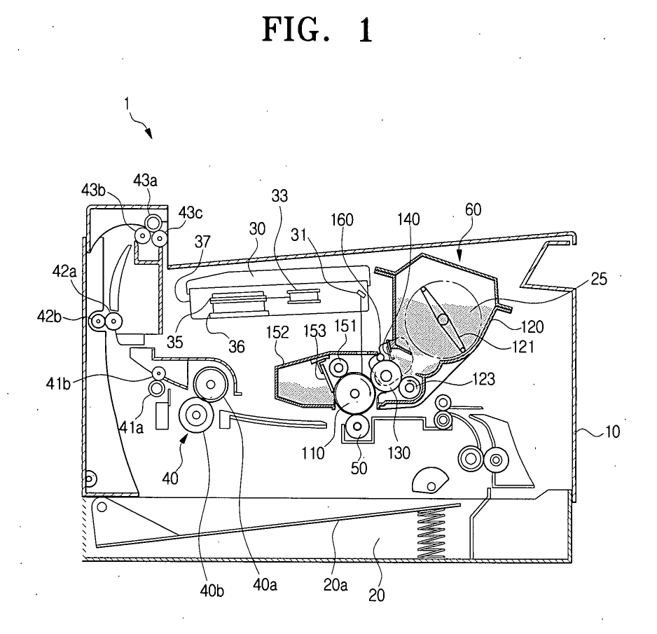

In FIG. 1, an image forming apparatus 1 according to an exemplary embodiment of the present general inventive concept includes a main body 10 thereof, a paper (or other suitable medium) feeder 20 (e.g., with tray or surface 20a), a laser scanning unit 30, a fixing unit 40, a transferring roller 50, and a developing unit 60.

The laser scanning unit 30 can operate according to an inputted image signal to scan a laser beam on an image carrier 110 of the developing unit 60. The laser scanning unit 30 can include a light source 31, a plurality of mirrors 33 (which can change the path of the laser generated by light source 31 and enable it to be incident on a polygon mirror 35 which can rotationally scan the laser beam onto the image carrier 110), and operating part 36 to operate the polygon mirror 35. The laser scanning unit 30 can be housed in casing 37.

The transferring roller 50 can be rotatably mounted in contact with the image carrier 110. An image formed on the image carrier 110 can be transferred to a printing medium (e.g., paper or other suitable medium) passing the image carrier 110 operating in conjunction with the transferring roller 50.

When the printing medium onto which the image is transferred passes through the developing unit 60, the fixing unit 40 can fix the image on the printing medium under high temperature and pressure by the use of, for example, roller 40a and roller 40b. One of rollers 40a and 40b may be a heating roller and the other a pressure roller. Since the paper (or other suitable medium) feeder 20, laser scanning unit 30, fixing unit 40, and transferring roller 50 can be conventional components known to those of ordinary skill in the art when taken in conjunction with this disclosure, a more detailed description of these components is omitted for brevity. However, a paper (or other suitable medium) exiting through fixing unit 40 can be guided by guide rollers 41a, 41b, 42a, 42b, 43a, 43b, and 43c onto a collection tray or outlet 44, for example.

The developing unit 60 can include an image carrier 110 to form an image (e.g., electrostatic latent image thereon), a developer container 120 to contain, store or hold a developer to be used when needed to form the image (e.g., to make the electrostatic latent image visible when contacted with an appropriate amount of developer) on the image carrier 110, a developer carrier 130 installed (e.g., wholly or partly) in the developer container 120, and a developer amount regulating member 140.

The image carrier 110 is charged with a predetermined voltage by a charging roller 151. The charged surface of the image carrier 110 is partially exposed by light scanned from the laser scanning unit 30, so that an electrostatic latent image is formed.

The developer container 120 can store a new or unused developer 25, such as a toner, that will be used in developing. The developer container 120 can have a configuration such that the developer 25 may be stirred by a stirring member 121 therein. Additionally, the developer container 120 can include a supplying roller 123 to supply the developer 25 to the developer carrier 130.

The developer carrier 130 can be roller-shaped to supply (or to then transfer) the developer 25 supplied from the supplying roller 123 onto the surface of the image carrier 110 to form a visual image corresponding to the electrostatic latent image, for example. Such a developer carrier 130 can be formed of a rubber material, and may have a hardness of approximately 75° to approximately 80° (on a JIS A scale). The developer carrier 130 can rotate in the opposite direction (counterclockwise) relative to the direction of rotation (clockwise) of the image carrier 110, and can rotate with a predetermined developing nip or developing gap maintained from a surface of the image carrier 110. Accordingly, the developer 25 of the developer carrier 130 can be transferred to an electrostatic latent image region formed on the image carrier 110.

Additionally, the developer amount regulating member 140 can be provided to regulate the amount of developer 25 transferred to the image carrier 110 by the developer carrier 130. A free end of the developer amount regulating member 140 can be in resilient contact with the developer carrier 130 under a predetermined amount of contact pressure. Accordingly, the amount of developer 25 attached to the surface of the developer carrier 130, that is, the thickness of a developer layer formed on the developer carrier 130 can be regulated. For example, when greater pressure is applied by the developer amount regulating member 140, then a smaller amount of developer 25 can be distributed on the surface of the developer carrier 130. Conversely, for example, when lesser pressure is applied by the developer amount regulating member 140, then a greater amount of developer 25 can be distributed on the surface of the developer carrier 130. By control of the amount of pressure applied onto the developer carrier 130 by the developer amount regulating member 140, the amount of developer 25 transferred onto the image carrier 110 can be controlled according to one or more embodiments of the present general inventive concept.

Referring to the embodiment of FIG. 1 of the present general inventive concept, reference number 152 refers to an excess (e.g., waste) developer container to store (or to hold) a waste or excess developer, and reference number 153 refers to a cleaning blade to remove the waste or excess developer attached to the image carrier 110. The waste or excess developer container 152 can be in a housing shape that may be connected to the developer container 120 or the excess developer container 152 may be provided separately from the developer container 120.

In this configuration, for example, to produce an image of high quality, precise positioning and/or alignment (and/or maintenance thereof, respectively) of the developer carrier 130 and the image carrier 110 together with constantly maintaining the appropriate developing gap can be extremely important. Additionally, precise positioning and/or alignment (and/or maintenance thereof, respectively) of the developer carrier 130 and the developer amount regulating member 140 can also be extremely important for obtaining high quality images. Therefore, it is desirable to stabilize one or more positions of the developer carrier 130, the image carrier 110, and/or the developer amount regulating member 140, respectively, and/or to install each of these component as close as possible to a designed position thereof.

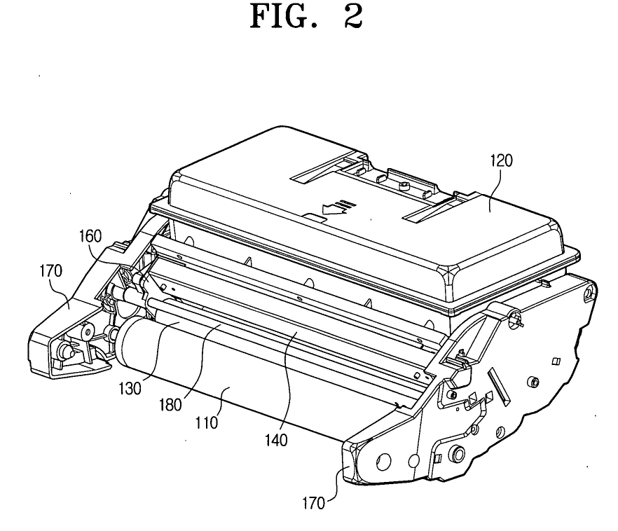

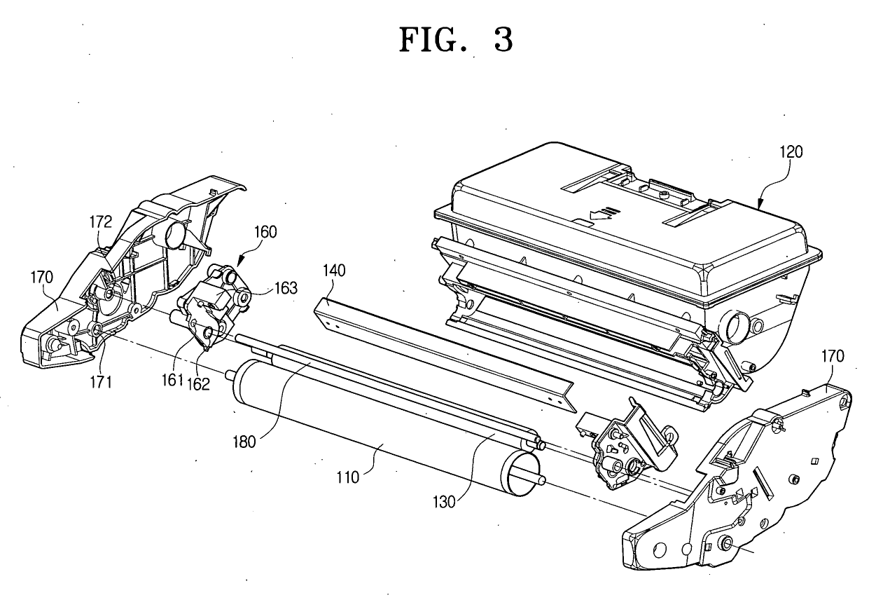

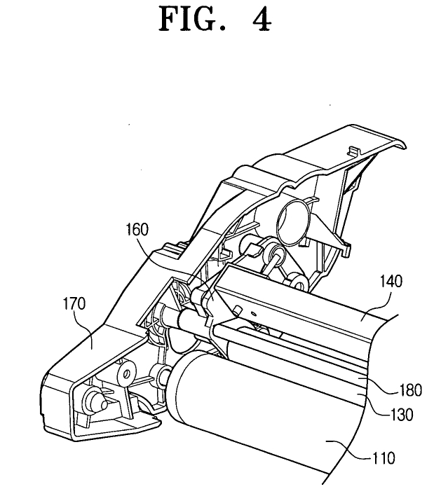

To this end, the developing unit 60 according to exemplary embodiments of the present general inventive concept can further include a support bracket 160 (e.g., two brackets, one on each side of the developer container 120, a frame 170 (e.g., two frames, one on each side of the developer container 120), and a hinge shaft 180 as illustrated in FIGS. 2, 3, and 4.

A pair of support brackets 160 can be respectively fixed to both sides of the developer container 120, and may be strongly secured to the developer container 120 by a screw (or other suitable fastener or equivalent thereof).

Both ends of the developer carrier 130 can be rotatably supported on the pair of support brackets 160. The developer amount regulating member 140 can be supported on the support brackets 160.

The hinge shaft 180 can be fixed to the support brackets 160. Specifically, both ends of the hinge shaft 180 can be shaped to fit into each of the pair of support brackets 160. The support brackets 160 can include a first hole 161 into which the hinge shaft 180 can be fitted and a second hole 162 into which a shaft of the developer carrier 130 can be inserted. Also, the support brackets 160 can include a supporting unit 163 to support the developer amount regulating member 140. The support brackets 160 may include, for example, pins to be coupled to holes of the developer amount regulating member 140.

The hinge shaft 180 can be fixed to the frames 170 or rotatably supported by the frames 170. In other words, the frames 170 can be installed respectively on both sides of developer container 120, and both ends of the hinge shaft 180 can respectively be fixed to (or supported by) a pair of frames 170.

The frames 170 can include first support bosses 171, each of which is respectively fixed to (or attached to and/or provide support to) one end of the image carrier 110 to support the image carrier 110, and second support bosses 172, each of which is respectively fixed to (or attached to or provide support to) one end of the hinge shaft 180 to support the hinge shaft 180. The hinge shaft 180 may be rotatably supported by a pair of the second support bosses 172, one disposed at each end of the hinge shaft 180. The frames 170 may include additional coupling holes or bosses to be coupled to bosses or holes of the support bracket 160 to fixedly place the support bracket 160 on the frame 170 with respect to the image carrier 110.

Because the support brackets 160, hinge shaft 180 and frames 170 can be provided as described above, the developer carrier 130 and the image carrier 110 may be precisely positioned and/or aligned according to one or more embodiments of the present general inventive concept. For example, the spatial relationship (e.g., position and/or alignment and/or maintenance thereof) between that of the developer carrier 130 and the image carrier 110 can be simplified when the developer container 120 is excluded from being positioned between the developer carrier 130 and the image carrier 110. Therefore, the developing gap or developing nip between the developer carrier 130 and the image carrier 110 can be better maintained as close as possible (or necessary) to the designed value thereof. Additionally, it is possible to reduce relative positional tolerances between such components due to assembly tolerances of parts and manufacturing tolerances, thereof.

In addition, because the developer amount regulating member 140 is not supported by the developer container 120 itself, but instead can be supported on the support brackets 160 fixed to the developer carrier 130, the precise positioning and alignment between the developer amount regulating member 140 and the developer carrier 130 may be more stably controlled, and/or a more stable contact pressure on the developer carrier 130 may be maintained.

As described above, in the developing unit and the image forming apparatus according to exemplary embodiments of the present general inventive concept, because the mechanical and contact relationship between the image carrier 110 and the developer carrier 130 is simplified, a smaller number of parts are interposed between the image carrier 110 and the developer carrier 130. Thus, assembly tolerances and manufacturing tolerances thereof can be reduced. Therefore, the precise positioning and/or alignment of the image carrier 110 and the developer carrier 130 may be more uniformly maintained, and unwanted relative positional changes between them can be reduced and/or minimized.

Additionally, the developer carrier 130 and the developer amount regulating member 140 can be fixed to the same member, that is, the support brackets 160, and thus, the precise positioning and/or alignment of the developer carrier 130 and the developer amount regulating member 140 can be stably maintained. Also, the developer carrier 130 can maintain a distance at the image carrier 110 and an angle with the image carrier 110 with respect to the hinge shaft 180, by using the support bracket 160. In addition, the developer amount regulating member 140 can maintain a distance and an angle with the developer carrier 130 with respect to the hinge shaft 180 by using the support brackets 160, which forms a single body.

In the above-described configurations, the amount of the developer 25 to be supplied, as well as the amount of developer 25 transferred from the developer carrier 130 to the image carrier 110 may be continuously controlled. Therefore, the quality of the visual image formed by and/or on the image carrier 110 can be improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A developing unit comprising:
an image carrier;
a developer container to contain a developer;
a developer carrier to transfer the developer of the developer container to the image carrier;
support brackets to be fixed to the developer container to rotatably support the developer carrier;
frames to rotatably support the image carrier; and
a hinge shaft fixed to each of the support brackets and supported by the frames.

2. The developing unit as claimed in claim 1, wherein the support brackets comprise a pair of support brackets respectively fixed to opposing sides of the developer container.

3. The developing unit as claimed in claim 2, wherein the hinge shaft has two opposing ends, one end of the hinge shaft is fixed to one of the pair of support brackets, and the other end of the hinge shaft is fixed to the other of the pair of support brackets.

4. The developing unit as claimed in claim 1, wherein the frames comprise a pair of frames rotatably supported on opposing ends of the hinge shaft.

5. The developing unit as claimed in claim 1, further comprising:
a developer amount regulating member supported by the support brackets to regulate the amount of developer supplied to the image carrier by the developer carrier.

6. An image forming apparatus comprising:
a main body; and
a developing unit mounted in the main body to form an image and to transfer the formed image to a printing medium passing between a transferring roller and the developing unit,
wherein the developing unit comprises:
an image carrier,
a developer container to contain a developer,
a developer carrier to transfer the developer of the developer container to the image carrier,
support brackets fixed to the developer container to rotatably support the developer carrier,
frames to rotatably support the image carrier, and
a hinge shaft fixed to each of the support brackets and supported by the frames.

7. The apparatus as claimed in claim 6, wherein the support brackets comprise a pair of support brackets respectively fixed to opposing sides of the developer container.

8. The apparatus as claimed in claim 7, wherein the hinge shaft comprises two opposing ends, wherein one end of the hinge shaft is fixed to one of the pair of support brackets, and wherein the other end of the hinge shaft is fixed to the other end of the pair of support brackets.

9. The apparatus as claimed in claim 6, wherein the frames comprise a pair of frames rotatably supported on opposing ends of the hinge shaft.

10. The apparatus as claimed in claim 6, further comprising:
a developer amount regulating member supported by the support brackets to regulate the amount of developer supplied to the image carrier by the developer carrier.

11. A developing unit comprising:
a frame;
a developer container to contain a developer;
an image carrier rotatably coupled to the frame;
a developer carrier to supply the developer of the developer container to the image carrier; and
a support bracket disposed between the frame and the developer carrier and to maintain a distance with the image carrier.

12. The developing unit of claim 11, further comprising:
a developer amount regulating member coupled to the support bracket to regulate the developer attached to the developer carrier.

13. The developing unit of claim 11, wherein the support bracket is fixedly coupled to the frame to support the developer carrier with respect to the frame.

14. The developing unit of claim 11, wherein the support bracket is spaced apart from a position of the frame where the image carrier is rotatably coupled to the frame.

15. The developing unit of claim 11, further comprising:
a hinge shaft coupled to the frame through the support bracket at a first position,
wherein the developer carrier is rotatably coupled to the support bracket at a second position.

16. The developing unit of claim 15, wherein the first position and the second position are separate from each other by a distance.

17. The developing unit of claim 15, wherein a rotation axis of the developer carrier forms an angle with a rotation axis of the image carrier with respect to the hinge shaft.

18. The developing unit of claim 11, wherein the frame comprises an image carrier boss to be coupled to the image carrier and a bracket boss to be coupled to the support bracket.

19. An image forming apparatus comprising:
a main body having a unit to feed a printing medium; and
a developing unit disposed in the main body to form an image on the printing medium, the developing unit comprising:
a frame;
a developer container to contain a developer;
an image carrier rotatably coupled to the frame;
a developer carrier to supply the developer of the developer container to the image carrier; and
a support bracket disposed between the frame and the developer carrier and to maintain a distance with the image carrier.

20. A development unit comprising:
a frame to which an image carrier is rotatably connected;
a developer container connected to the frame;
a support bracket connected to the frame and having a boss unit; and
a developer carrier rotatably connected to the boss unit of the support bracket with respect to the image carrier to supply the developer from the developer container to the image carrier.
